(19) United States
(12) Patent Application Publication
(10) Pub. No.: US 2009/0174546 A1
(43) Pub. Date: Jul. 9, 2009

(54) SYSTEM AND METHOD FOR DETERMINING LOCATION OF OBJECTS

(75) Inventors: Ming-Ren LIAN, Boca Raton, FL (US); Hubert A. PATTERSON, Boca Raton, FL (US); Kevin D. ROMER, Boca Raton, FL (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 11/969,524

(22) Filed: Jan. 4, 2008

(51) Int. Cl. G08B 1/08

(52) U.S. Cl. 340/539.1; 340/825.49

(57) ABSTRACT

An object tracking system, method and computer product, that include a remote communication device associated with the object to be tracked that includes a transmitter for broadcasting a tracking signal, and a search unit, that includes a receiver receiving the tracking signal from the remote communication device, and a processor analyzing the received tracking signal from the remote communication device to derive a relative direction and a relative distance to the remote communication device from the search unit.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to wireless communication systems, and in particular to object tracking systems.

### BACKGROUND OF THE INVENTION

Tracking and monitoring devices for detecting the location and movement of assets, objects, people or animals are used in a variety of applications. Whether for monitoring the whereabouts of a firefighter as a safety check or for tracking objects in a warehouse, such systems allow one to easily and more effectively track and monitor objects, such as assets, people or animals from a remote location.

There are a variety of existing systems that utilize inertial measurement systems (“IMS”) for determining an object's relative position. In accordance with such systems, a person wears a small device which has an inertial measurement unit (“IMU”). An IMU usually has a “clump” of six inertial sensors, e.g., three linear accelerometers and three rate gyroscopes. The angular rate sensors or gyroscopes, commonly known as gyros, are susceptible to fixed offsets or biases which are a significant source of error in inertial measurements. The magnitude of these fixed offset errors depends upon the type of sensor or gyroscope used. In applications with stringent limits on offset errors, more expensive sensors with very low residual offset errors must generally be used, and those sensors are often relatively large and heavy. Such IMS systems also suffer from long-term drift problems, and overall position error accumulates over time.

There are a variety of existing systems which utilize a global positioning system (“GPS”) for determining a person's position relative to geographical coordinates. In accordance with such systems, a person wears a small device which receives and triangulates signals from geostationary satellites, and determines the geographical coordinates of the device's current location. The triangulation of such systems requires fixed nodes and specific procedures that may not be practical in emergency situations or in situations where the person is indoors to a facility that may partially or fully obstruct the GPS signals.

What is needed is an inexpensive locating and monitoring system that can be used to detect the location and movement of objects, such as assets, people or animals.

### SUMMARY OF THE INVENTION

In accordance with one aspect, the present invention advantageously provides an object tracking system. The system includes a remote communication device associated with the object to be tracked that includes a transmitter for broadcasting a tracking signal. A search unit includes a receiver receiving the broadcasted tracking signal from the remote communication device. A processor analyzes the received tracking signal from the remote communication device. The processor derives a relative direction and a relative distance to the remote communication device from the search unit. The remote communication device of the object tracking system can further include a receiver to receive a tracking signal from the search unit.

In accordance with another aspect, the present invention provides a method for tracking an object that includes activating a remote communication device associated with the object to be tracked, broadcasting a tracking signal from the remote communication device, using a search unit to receive the broadcasted tracking signal from the remote communication device, and analyzing the received tracking signal from the remote communication device to derive a relative direction and a relative distance to the remote communication device with respect to the search unit. The method further includes initiating self activation by the remote communication device upon detecting a hazardous condition.

In accordance with another aspect, the present invention provides a computer program product that includes a computer usable medium having a computer readable program for tracking an object, which when executed on a computer causes the computer to perform a method that includes activating a remote communication device associated with the object to be tracked, broadcasting a tracking signal from the remote communication device, using a search unit to receive the broadcasted tracking signal from the remote communication device, and analyzing the received tracking signal from the remote communication device to derive a relative direction and a relative distance to the remote communication device with respect to the search unit.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary object tracking constructed in accordance with the principles of the present invention;

FIG. 2 is a block diagram of another exemplary object tracking constructed in accordance with the principles of the present invention; and

FIG. 3 is a flowchart of an exemplary object tracking process in accordance with the principles of the present invention.

### DETAILED DESCRIPTION OF THE INVENTION

As used herein in the illustrative embodiment, the term “object” refers to the tracked/monitored entity and can include, but is not limited to, a person, an animal, a thing, an asset, etc.

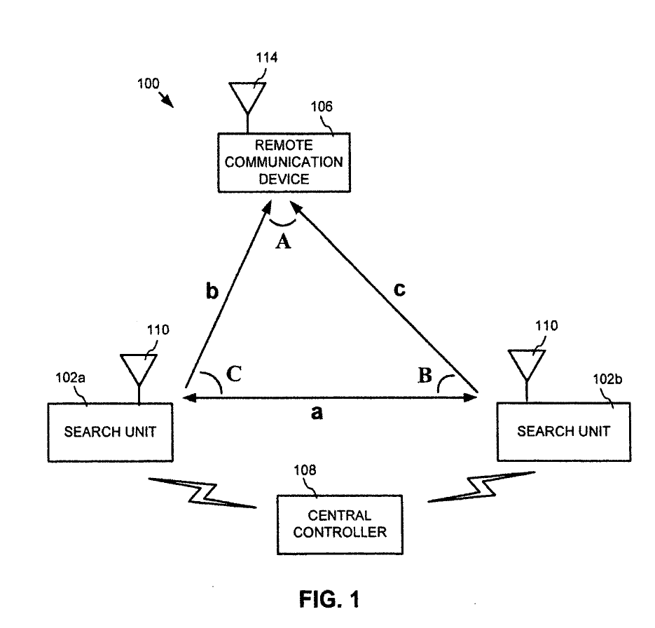

Referring now to the drawing figures in which like reference designators refer to like elements, there is shown in FIG. 1 a diagram of an exemplary system constructed in accordance with the principles of the present invention and designated generally as “100”. Locating system 100 can include one or more search units 102a and 102b (collectively referred to herein as search units 102), one or more remote communication devices or units 106 and an optional central controller 108. Search unit 102 can include a transceiver 110 that is used to detect and monitor a remote communication device 106 that is attached or affixed to an object or person to be tracked, a portable power source that enables the mobile movement of the search unit 102 and a processor to perform the functions described herein. In this embodiment, search units 102 function in similar ways and have similar features, e.g., both units have the capability to transmit and receive tracking signals, but could have different functions, such as search unit 102a having the capability to receive but not transmit tracking signals.

In the embodiment illustrated in FIG. 1, search units 102 communicate with each other and the optional central controller 108 using a conventional RF scheme and protocol. Alternative means of communications include microwave, radio frequency, spread spectrum, ultra wideband (“UWB”) and proprietary RF encoding/decoding schemes. Search units 102 also communicate with remote communication device 106 using a conventional RF scheme and protocol. In this embodiment, remote communication device 106 includes a power source and a transmitter to transmit a radio frequency signal of a specific signature that is recognized by search units 102. Remote communication device 106 can also include a processor such as a microcontroller, CPU, etc. to perform more advanced functions such as to obtain and process control data received from a search unit 102. Such control data might include, remote light activation, transmitter activation and the like. Upon receiving the transmitted RF signal by remote communication device 106, search units 102 process the received RF signal to determine the direction of the remote communication device 106 with reference to each search unit 102 and determine the distance of the remote communication device 106 with reference to each search unit 102.

For example, angle B, which is the relative direction of remote communication device 106 with reference to search unit 102a and angle C which is the relative direction of remote communication device 106 with reference to search unit 102b, can be measured (derived) by conventional means such as angle of arrival (“AOA”). The distance “a” between search units 102 can be measured with a substantial amount of precision by measuring the time of arrival (“TOA”) round trip from two search units, e.g., search units 102a and 102b. The distance “b” between search unit 102a and remote communication device 106 and the distance “c” between search unit 102b and remote communication device 106 can each be measured by conventional means such as received signal strength indicator (“RSSI”). In this embodiment, distance between remote communication device 106 and search units 102 can be determined or derived by measuring the magnitude of the received signal and calibrating the received signal to a standard path loss mechanism. Additionally, by measuring a change of the received signal strength, search unit 102 provides an indication of whether a user is advancing toward or away from the remote communication device 106.

However, amplitude attenuation of the RF signal is typically less accurate than other distance measurement means such as time of arrival or latency time differential. In an alternative embodiment, the distances “b” and “c” can be determined using triangulation based on time of arrival, provided an absolute time stamp can be established, which improves the reliability and accuracy of the measured distance between each search unit 102 and communication device 106.

One way to measure direction and distance of remote communication device 106 with reference to each search unit 102 is to derive the length of time required for a RF waveform to travel from remote communication device 106 to search unit 102. Where there is a common time base available for both remote communication device 106 and search unit 102 the time it takes for the RF waveform to travel from remote communication device 106 to the search unit 102 can be accurately determined and thus the distance in between can be derived. However, for cases where no common time base exists, time of arrival measurements can be determined by using a pair of transceivers, e.g., search units 102. The RF signal can be initiated from one search unit, e.g., search unit 102a, and received by the second search unit, e.g., search unit 102b. Upon receiving the RF signal from the first search unit, the second search unit promptly transmits a second signal back. The total time required for this process will be approximately equal to twice the length of time required for an electromagnetic wave to travel from one search unit to the other search unit, plus the total latency period of the second search unit during its response. The total time for the round trip of the RF signal can be used to derive the distance between the two search units 102. The distance between the two search units 102 can be used in a triangulation procedure (as discussed more fully below) to calculate the relative position, e.g., the relative distance and the relative direction of the remote communication device 106 with respect to each search unit 102.

Different techniques may result in varying degrees of measurement accuracy. For example, the distance “b” or “c” between search units 102 and the remote communication device 106 can be measured by received RF intensity in units 102, which may subject to inaccuracy due to environment factors, such as multiple paths. Based on the above method, the distance “b” and “c” can be measured to be, e.g. 15.6 meters and 10.3 meters respectively. A second method to identify the location of the remote communication device is by triangulation using at least two search units, 102a and b. The distance “a” e.g., 12 meters, between the two search units 102, the angle “C”, e.g., 35 degrees, between search unit 102a and the remote communication device 106, and the angle “B”, e.g., 110 degrees, between search unit 102b and the remote communication device 106 can be measured. Angle “A” can be calculated using the formula angle A=180 degrees−angle B−angle C. For this example, angle A is 35 degrees. The distance “c” between search unit 102b and the remote communication device 106 can be calculated using triangulation and the formula, distance “c”=a (sin C/sin A). The distance “b” between search unit 102a and the remote communication device 106 also can be calculated using triangulation and the formula, distance “b”=a (sin B/sin A). The calculated distances “b” and “c” can be obtained through above formulations, and the measured distance “a” and angles “B” and “C” to be 12 meters, and 19.6 meters respectively. These calculated values can then be compared with the measured values, which provides a better overall indication for the location of the remote control unit. The preceding example is meant to be illustrative of one embodiment of system 100 and is not meant to be limited to the values discussed therein.

In another embodiment, search units 102 can also include global positioning system (“GPS”) technology so that a search unit's location is transmitted to the other search units 102 or to a central control station, e.g., optional central controller 108, at regular intervals. In this embodiment, the search units 102 can include a GPS receiver or transceiver, which can provide precise location of the search units 102 to assist in a more reliable determination of the location of the remote communication device 106 with respect to a structure, e.g., the layout of a building.

In another embodiment, remote communication device 106 includes the capability to interface with an emergency system, e.g., a fire alarm system panel, of a building to activate the emergency system when a hazardous event, e.g., a fire, is detected. The remote communication device 106 also can be configured to prohibit activation of tracking system 100 until certain conditions occur, such as upon detection of a hazardous event, e.g., a fire, and then limit activation to that location where the hazardous event occurs. In other words, tracking system 100 will remain disabled until the remote communication device 106 detects a hazardous event, e.g., firefighter injury, at which time the remote communication device 106 can be activated, e.g., the transmitter of remote communication device 106 is enabled, to broadcast a tracking signal to one or more search units 102.

In another embodiment, remote communication device 106 can wirelessly communicate between search units 102 and central controller 108 to allow a building system to communicate with the operator of the remote communication device 106. This advantageously provides for communications when the operator of the remote communication device 106 is positioned near the source of the hazardous event or alarm.

Optional central controller 108 can include a search unit transceiver 102 that is used to directly detect and monitor remote communication device 106. Alternatively, controller 108 can communication with and control separate search units 102. Controller 108 includes a processor to perform the functions described herein and can further include memory for data storage, interfaces for I/O operation and interaction by a user, network interfaces, etc. For example, optional central controller can compile and store a location table using the angle measurements and distance measurements calculated by search units 102 for remote communication device 106.

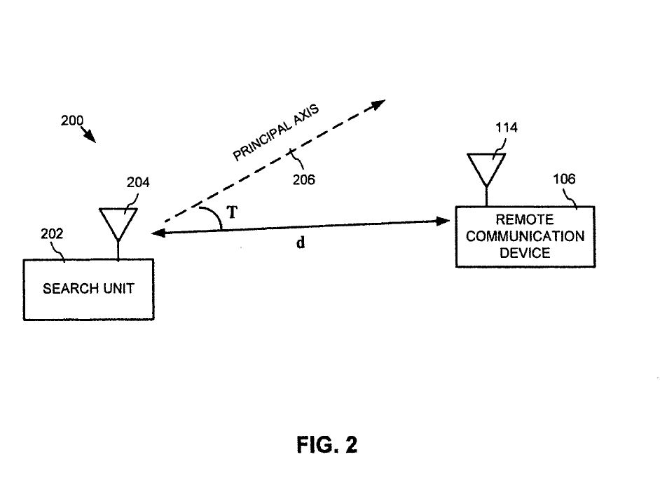

FIG. 2 is a diagram of another exemplary locating system constructed in accordance with the principles of the present invention and designated generally as “200”. Locating system 200 can include search unit 202 and one or more remote communication devices or units 106. Search unit 202 can include a receiver 204 that is used to detect and monitor a remote communication device 106 that is attached or affixed to an object or person to be monitored, a portable power source that enables the mobile movement of the search unit 202 and a processor that performs the functions described herein. In this embodiment, search unit 202 is simplified to have only the receive functionality of search units 102 of FIG. 1, and thereby provides an even lower cost alternative for monitoring objects.

As illustrated in FIG. 2, search unit 202 includes a principle axis 206 of receiver 204 that provides a reference axis with which to determine a direction of the remote communication device 106 with respect to the search unit 202. In this embodiment, the directional angle is illustrated as angle T. In order to derive the distance “d” between search unit 202 and remote communication device 106, the magnitude of the received signal will be measured and calibrated to the standard path loss mechanism. Furthermore, by measuring the change in the received signal strength, the user of the receiver search unit 202 provides an indication of whether a user is moving toward or away from the remote communication device 106. As discussed above with reference to FIG. 1, there are various ways to determine and/or measure the relative direction between remote communication device 106 and search unit 202.

For example, search unit 202 is equipped with a narrow-beam, highly directional antenna that can be used by an operator of search unit 202 to determine a direction to remote communication device 106. The direction is established at the directional point where the maximum signal strength is received from remote communication device 106. In an alternative embodiment, an antenna array is deployed to use phase information and/or arrival time differentiation to determine the relative direction of the transmitting remote communication device 106. In one embodiment, the RF frequency is greater than 1 GHz, which advantageously minimizes antenna size and produces a more accurate time and/or phase measurement. The RF tracking signal can be a conventional RF scheme and protocol including microwave, radio frequency, spread spectrum, IEEE 802.11 based protocol (“WiFi”), IEEE 802.16 based protocol (“WiMAX”), IEEE 802.15.4 based protocol (“ZigBee”), ultra wideband (“UWB”) and proprietary RF encoding/decoding schemes. An ultra wideband signal has a sharp pulse, which is most suitable for time measurement without severe multi-path problems, i.e., overlapping of the signal because the signal takes many different paths to the receiver.

Referring again to FIG. 1, another embodiment of locating system 100 can include remote communication devices 106 that have transmit and receive functionality similar to the transmit and receive functionality of search units 102. In this embodiment, remote communication device 106 can transmit and receive the wireless signals, e.g., ultra wide bandwidth pulse RF signals, to and from search units 102. As a result, the distances between remote communication device 106 and search unit 102, remote communication device 106 and search unit 102 and search units 102a and 102b, denoted as “c”, “b”, and “a” can be measured with greater accuracy. In addition, angle B and angle C can be measured, which in combination with the measured distances “c”, “b”, and “a” provides for greater accuracy in determining the location of remote communication device 106. In this embodiment, where remote communication device 106 can transmit and receive the wireless signals, locating network 100 can also serve as a traditional communication network.

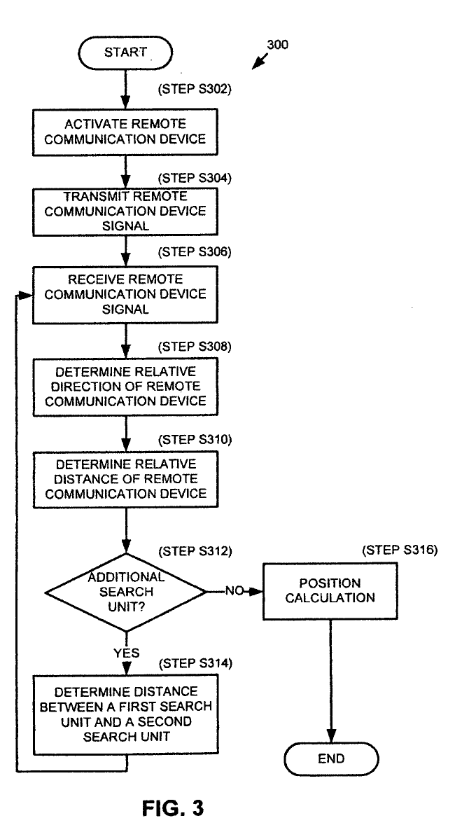

FIG. 3 is a flow chart of an exemplary method 300 for locating and monitoring a remote communication device 106. Exemplary method 300 is discussed with reference to locating system 100. However, it is contemplated that any other suitable system or portion of a system may use appropriate embodiments of method 300 to determine and process tracking signals to locate the remote communication device 106. Generally, method 300 describes locating a remote communication device 106 that transmits a tracking signal, e.g., a conventional RF signal, by using one or more search units 102 to process the transmitted tracking signal to determine the relative direction and the relative distance of the remote communication device 106 with reference to the respective search unit 102.

At step S302, a remote communication device 106 is activated, e.g., on demand of the device user or on demand of the optional central controller 108. Additionally, remote communication device 106 can be self-activated in certain environments of distress, such as during a building fire or a downed firefighter. After activation, the remote communication device 106 transmits a tracking signal, e.g., conventional RF or ultra wideband signal (step S304). At step S306, the transmitted signal of the communication device 106 is recognized and received by one or more search units 102. A first search unit 102 processes the transmitted signal of the communication device 106 to determine the relative direction of communication device 106 with respect to the first search unit 102 (step S308).

At step S310, first search unit 102 processes the transmitted signal of the communication device 106 to determine the relative distance of communication device 106 from the first search unit 102. At step S312, an inquiry is made as to whether there are any additional search units 102 in the locating system 100 and if so, the distance between the first search unit 102 and the second search unit is derived (step S314) and the process returns to step S306. The additional search unit 102 can receive the previously broadcasted signal of remote communication device 106 or receive another broadcasted signal from another remote communication device 106 (step S306) for processing to determine a relative direction (step S308) and a relative distance (step S310) of a remote communication device 106. If there are no additional search units 102, then the information acquisition process can terminate (step S312), and position determination of communication device 106 commences, such as via triangulation (step S316).

The present invention advantageously provides and defines a comprehensive system and method for tracking an object using a variety of wireless communication protocols.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An object tracking system, the system comprising:
a remote communication device associated with the object to be tracked, the remote communication device including a transmitter broadcasting a tracking signal; and
a search unit, the search unit including:
a receiver for receiving the broadcasted tracking signal from the remote communication device, and
a processor, the processor analyzing the received tracking signal from for the remote communication device to derive a relative direction and a relative distance to the remote communication device from the search unit.

2. The tracking system of claim 1, wherein the derivation of the relative direction and the relative distance to the remote communication device is based on time of arrival of the tracking signal.

3. The tracking system of claim 2, wherein the remote communication device includes a processor, the processor analyzing the tracking signal from the search unit to obtain control data.

4. The tracking system of claim 1, wherein the search unit includes a directional antenna for receiving the tracking signal.

5. The tracking system of claim 1, wherein the search unit includes an antenna array for receiving the tracking signal.

6. The tracking system of claim 1, wherein the remote communication device is arranged to self-activate upon detecting a hazardous condition.

7. The tracking system of claim 1, wherein the search unit includes a global positioning system transceiver.

8. The tracking system of claim 1, further comprising a central controller in communication with at least one search unit, the central controller storing the relative direction and the relative distance to a plurality of remote communication devices based on data obtained from the at least one search unit.

9. A method for tracking an object, the method comprising:
activating a remote communication device associated with the object to be tracked;
broadcasting a tracking signal from the remote communication device;
using a search unit to receive the broadcasted tracking signal of the remote communication device; and
analyzing the received tracking signal from the remote communication device to derive a relative direction and a relative distance to the remote communication device with respect to the search unit.

10. The method of claim 9, wherein activating a remote communication device includes self activation initiated by the remote communication device upon detecting a hazardous condition.

11. The method of claim 9, further comprising using a directional antenna to receive the broadcasted tracking signal.

12. The method of claim 9, further comprising determining a distance between a first search unit and a second search unit.

13. The method of claim 9, wherein deriving the relative distance to the remote communication device from the search unit includes measuring the broadcasted tracking signal and applying a path loss technique.

14. The method of claim 9, wherein deriving the relative distance to the remote communication device from the search unit includes deriving the length of time the broadcasted tracking signal takes to travel from the search unit to the remote communication device.

15. The method of claim 9, wherein deriving the relative direction to the remote communication device from the search unit includes establishing a directional point where a maximum signal strength from the remote communication device is received by the search unit.

16. The method of claim 9, wherein deriving the relative direction to the remote communication device from the search unit includes establishing a directional point using phase array of the broadcast signal from the remote communication device.

17. A computer program product comprising a computer usable medium having a computer readable program for an object tracking system which when executed on a computer causes the computer to perform a method comprising:
activating a remote communication device associated with the object to be tracked;
broadcasting a tracking signal from the remote communication device;
using a search unit to receive the broadcasted tracking signal from the remote communication device; and
analyzing the tracking signal received from the remote communication device to derive a relative direction and a relative distance to the remote communication device with respect to the search unit.

18. The method of claim 17, wherein activating a remote communication device includes self activation initiated by the remote communication device upon detecting a hazardous condition.

19. The method of claim 17, wherein deriving the relative distance to the remote communication device from the search unit includes measuring the broadcasted tracking signal and applying a path loss technique.

20. The method of claim 17, wherein deriving the relative distance to the remote communication device from the search unit includes deriving the length of time the broadcasted tracking signal takes to travel from the search unit to the remote communication device.
